(19) United States
(12) Patent Application Publication
(10) Pub. No.: US 2013/0250192 A1
(43) Pub. Date: Sep. 26, 2013

(54) 3D DISPLAY DEVICES

(71) Applicants: Satoru Takahashi, Miao-Li County (TW); Toshiya Inada, Miao-Li County (TW)

(72) Inventors: Satoru Takahashi, Miao-Li County (TW); Toshiya Inada, Miao-Li County (TW)

(73) Assignees: CHIMEI INNOLUX CORPORATION, Miao-Li County (TW); INNOCOM TECHNOLOGY(SHENZHEN) CO., LTD., Longhua Town (CN)

(21) Appl. No.: 13/430,416

(22) Filed: Mar. 26, 2012

(51) Int. Cl. G02F 1/1335

(52) U.S. Cl. 349/15

(57) ABSTRACT

In an embodiment of the invention, a 3D display device is provided. The 3D display device includes: a backlight system with a reflector disposed thereunder; a reflective barrier disposed above the backlight system; and a liquid crystal display (LCD) panel disposed above the backlight system. The 3D display device includes fixed-barrier-type 3D display devices and switchable-barrier-type 3D display devices.

### BACKGROUND OF THE INVENTION

1. Field of the Invention

The invention relates to a 3D display device, and in particular to a 3D display device with a reflective barrier.

2. Description of the Related Art

In recent years, continuous advancement of display technologies has resulted in an increasing demand for a higher quality of display, such as higher image resolution, brightness, and so on. For 3D image display, high image resolution and high brightness are priorities.

For current 3D image display technologies, a fixed barrier is mainly utilized for controlling images viewed by the respective eyes of an observer. According to the visual characteristics of human eyes, when two images with the same content but different parallaxes are respectively viewed by an observer's left eye and right eye, two images are overlapped and interpreted as a 3D image (stereoscopic image) by his brain.

It should be noted that a 3D image is produced by the fixed barrier in a spatial-multiplexed manner, such that the resolution is reduced in half at some axis and light will be absorbed by the barriers. Also, the 3D display with fixed barrier cannot display 2D images but 3D images. Thus, the 3D display with fixed barrier cannot be extensively applied.

To solve said issue, a switchable barrier has been proposed and applied. The display with switchable barrier (switchable 2D/3D display) is able to display 2D images when the switchable barrier is turned off and display 3D images when the switchable barrier is turned off Specifically, in a conventional switchable 2D/3D display, a normally white mode TN-LC cell is usually used as the switchable barrier. Nonetheless, the switchable 2D/3D display should improve quality, such as brightness, contrast, symmetrical viewing angles, and so on.

### BRIEF SUMMARY OF THE INVENTION

One embodiment of the invention provides a 3D display device, comprising: a backlight system with a reflector disposed thereunder; a reflective barrier disposed above the backlight system; and a liquid crystal display (LCD) panel disposed above the backlight system.

In an embodiment, the reflective barrier comprises a plurality of protrusions. The protrusion comprises an anti-reflective layer and a reflective layer disposed on the anti-reflective layer.

In an embodiment, the reflective barrier comprises a first polarizer, a switchable barrier panel and a second polarizer. The switchable barrier panel is disposed between the first polarizer and the second polarizer. The first polarizer has a transmission axis and an absorption axis. The switchable barrier panel comprises a first substrate, a twisted nematic (TN) liquid crystal layer and a second substrate. The twisted nematic (TN) liquid crystal layer is disposed between the first substrate and the second substrate. When the switchable barrier panel is turned on, the twisted nematic (TN) liquid crystal layer is divided into an on-state area and an off-state area in an alternate arrangement. In the on-state area, liquid crystals are vertically arranged. In the off-state area, liquid crystals are horizontally arranged. The second substrate has a thickness less than a distance between the two on-state areas or two off-state areas. The second polarizer comprises a high-refractive-index polymer layer and a low-refractive-index polymer layer in an alternate arrangement. The second polarizer has a transmission axis and a reflection axis. The transmission axis of the first polarizer and the transmission axis of the second polarizer are substantially perpendicular to each other. The reflection axis of the second polarizer and the transmission axis of the first polarizer are substantially parallel to each other.

In an embodiment, the reflective barrier comprises a first polarizer, a switchable barrier panel and a second polarizer. The second polarizer is inserted into the switchable barrier panel. The first polarizer has a transmission axis and an absorption axis. The switchable barrier panel comprises a first substrate, a twisted nematic (TN) liquid crystal layer and a second substrate. The twisted nematic (TN) liquid crystal layer is disposed between the first substrate and the second polarizer. When the switchable barrier panel is turned on, the twisted nematic (TN) liquid crystal layer is divided into an on-state area and an off-state area in an alternate arrangement. In the on-state area, liquid crystals are vertically arranged. In the off-state area, liquid crystals are horizontally arranged. The second polarizer comprises a high-refractive-index polymer layer and a low-refractive-index polymer layer in an alternate arrangement. The second polarizer has a transmission axis and a reflection axis. The transmission axis of the first polarizer and the transmission axis of the second polarizer are substantially perpendicular to each other. The reflection axis of the second polarizer and the transmission axis of the first polarizer are substantially parallel to each other.

In an embodiment, the reflective barrier comprises a first polarizer, a switchable barrier panel, a second polarizer and a third polarizer. The switchable barrier panel is disposed between the first polarizer and the second polarizer. The third polarizer is disposed on the second polarizer. The first polarizer has a transmission axis and an absorption axis. The switchable barrier panel comprises a first substrate, a twisted nematic (TN) liquid crystal layer and a second substrate. The twisted nematic (TN) liquid crystal layer is disposed between the first substrate and the second substrate. When the switchable barrier panel is turned on, the twisted nematic (TN) liquid crystal layer is divided into an on-state area and an off-state area in an alternate arrangement. In the on-state area, liquid crystals are vertically arranged. In the off-state area, liquid crystals are horizontally arranged. The second substrate has a thickness less than a distance between the two on-state areas or two off-state areas. The second polarizer comprises a high-refractive-index polymer layer and a low-refractive-index polymer layer in an alternate arrangement. The second polarizer has a transmission axis and a reflection axis. The third polarizer has a transmission axis and an absorption axis. The transmission axis of the first polarizer and the transmission axis of the second polarizer are substantially perpendicular to each other. The reflection axis of the second polarizer and the transmission axis of the first polarizer are substantially parallel to each other. The transmission axis of the second polarizer and the transmission axis of the third polarizer are substantially parallel to each other. The absorption axis of the third polarizer and the reflection axis of the second polarizer are substantially parallel to each other.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIG. 1A shows a cross-section view of a 3D display device according to an embodiment of the invention;

FIG. 1B shows light paths within a 3D display device according to an embodiment of the invention;

FIG. 2A shows a cross-section view of a 3D display device according to an embodiment of the invention;

FIG. 2B shows a light path within a 3D display device according to an embodiment of the invention;

FIG. 2C shows a light path within a 3D display device according to an embodiment of the invention;

FIG. 3A shows a cross-section view of a 3D display device according to an embodiment of the invention;

FIG. 3B shows a light path within a 3D display device according to an embodiment of the invention;

FIG. 3C shows a light path within a 3D display device according to an embodiment of the invention

FIG. 4A shows a cross-section view of a 3D display device according to an embodiment of the invention; and

FIG. 4B shows sunlight readability of a 3D display device according to an embodiment of the invention.

### DETAILED DESCRIPTION OF THE INVENTION

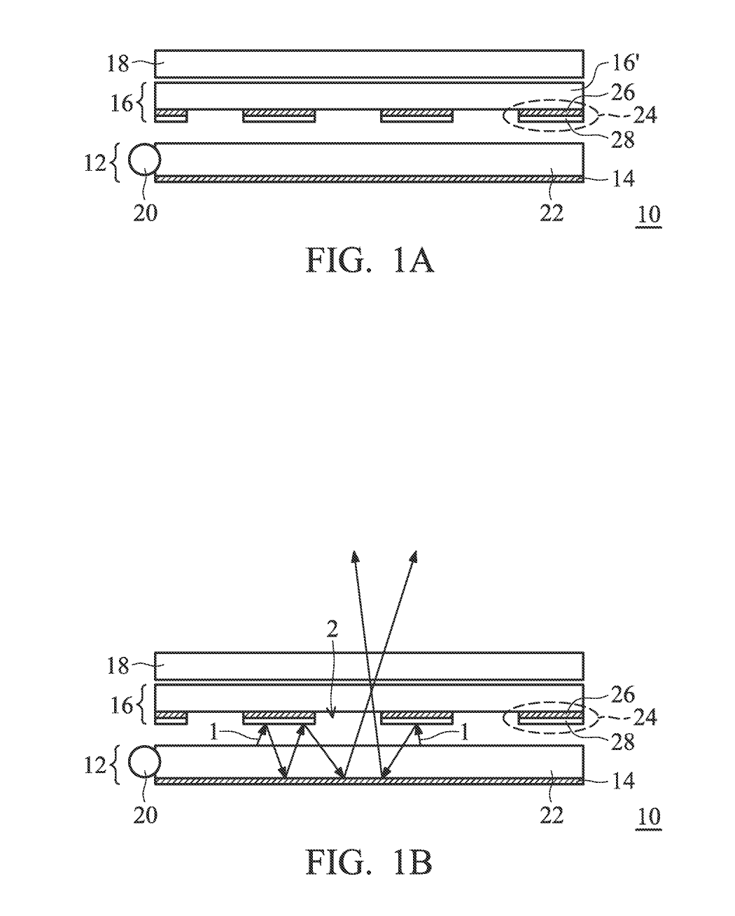

According to one embodiment of the invention, referring to FIG. 1A, a 3D display device with fixed barrier is illustrated. The 3D display device 10 comprises a backlight system 12, a reflective barrier 16 and a liquid crystal display (LCD) panel 18. The liquid crystal display (LCD) panel 18 is disposed above the reflective barrier 16. The liquid crystal display (LCD) panel 18 is a transmissive display panel for displaying images. The reflective barrier 16 is disposed between the liquid crystal display (LCD) panel 18 and the backlight system 12.

In this embodiment, the backlight system 12 comprises at least one light source 20, one light guide plate 22, and one reflector 14. The reflector 14 is disposed under the light guide plate 22. Additionally, the reflector 14 may comprise metal such as aluminum (Al), silver (Ag) or chromium (Cr).

In this embodiment, the reflective barrier 16 comprises a plurality of protrusions 24 on a substrate 16′ as fixed barriers. The protrusion 24 comprises an anti-reflective layer 26 on the substrate 16′ and a reflective layer 28 disposed on the anti-reflective layer 26. The anti-reflective layer 26 may comprise resin or metal oxide such as chromium oxide (CrOₓ). The anti-reflective layer 26 can absorb the ambiance light and maintain the contrast ratio for outdoor readability. The reflective layer 28 may comprise metal such as aluminum (Al), silver (Ag) or chromium (Cr). In an embodiment, when metal is used as the reflective layer 28, the corresponding metal oxide can be used as the anti-reflective layer 26, for example when “chromium (Cr)” is used as the reflective layer 28, the corresponding metal oxide “chromium oxide (CrOₓ)” is used as the anti-reflective layer 26.

Referring to FIG. 1B, in this embodiment, within the 3D display device 10, a part of light 1 emitted from the light source 20 can be alternately reflected between the reflective layer 28 and the reflector 14 as finally passing through an window 2 between the protrusions 24. The process of alternately reflection improves light recycling efficiency to enhance total brightness.

In an embodiment, the brightness of the 3D display device 10 (with an aperture ratio of 30%) is improved from 30% (conventional fixed-barrier-type 3D display device) to about 69%.

In this embodiment, some structural features of the 3D display device 10 are: (1) the liquid crystal display panel 18 is a transmissive display panel for displaying images; (2) the reflector 14 is disposed under the light guide plate 22 of the backlight system 12; (3) the reflective barrier 16 is located between the liquid crystal display panel 18 and the backlight system 12; (4) the reflective barrier 16 is composed of high-reflective material; and (5) the 3D display device 10 is a fixed-barrier-type 3D display device.

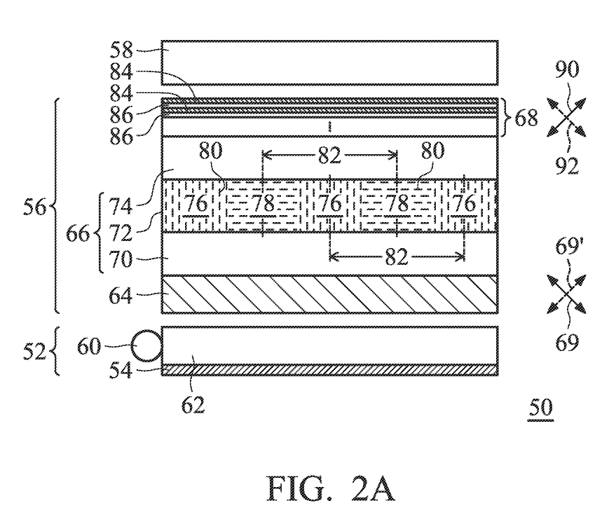

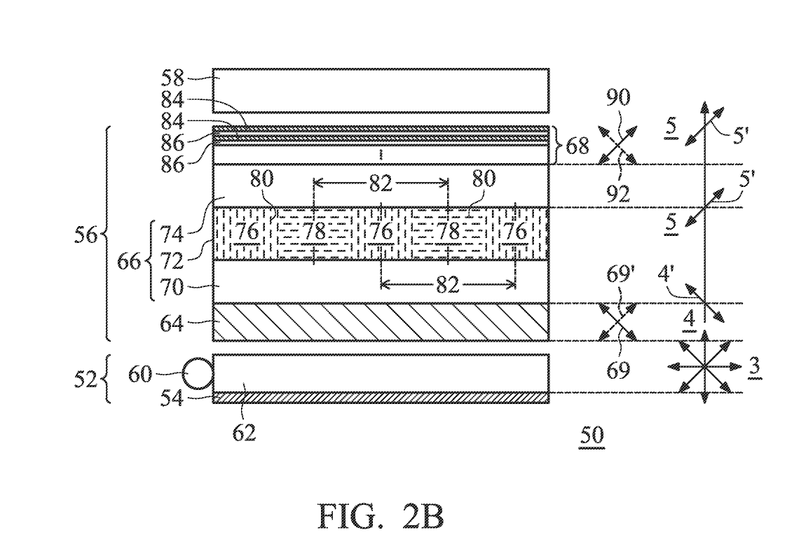

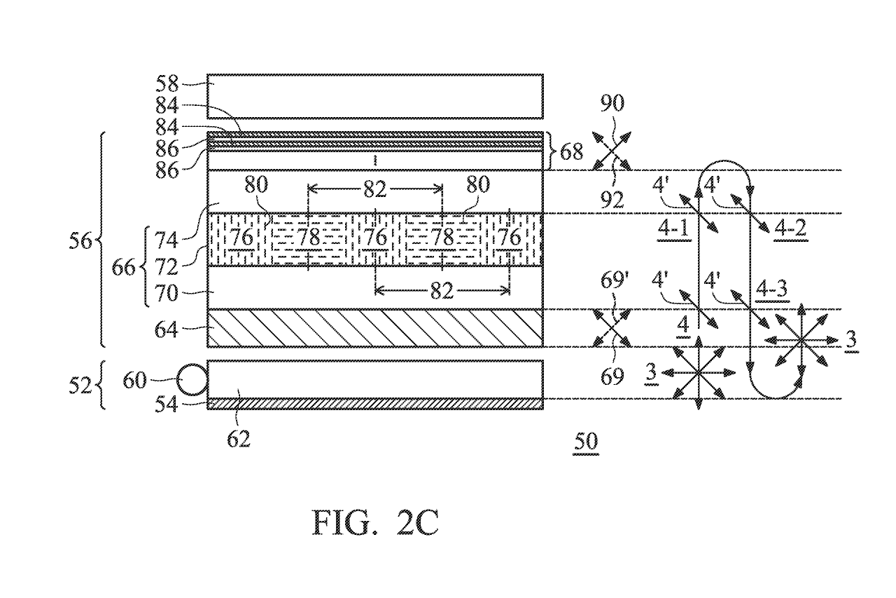

According to another embodiment of the invention, referring to FIG. 2A, a 3D display device with switchable barrier is illustrated. A 3D display device 50 comprises a backlight system 52, a reflective barrier 56 and a liquid crystal display (LCD) panel 58. The liquid crystal display (LCD) panel 58 is disposed above the reflective barrier 56. The liquid crystal display (LCD) panel 58 is a transmissive display panel for displaying images. The reflective barrier 56 is disposed between the liquid crystal display (LCD) panel 58 and the backlight system 52. In another embodiment, the liquid crystal display (LCD) panel 58 is disposed between the reflective barrier 56 and the backlight system 52 (not shown).

In this embodiment, the backlight system 52 comprises at least one light source 60, one light guide plate 62 and one reflector 54. The reflector 54 is disposed under the light guide plate 62. Additionally, the reflector 54 may comprise metal such as aluminum (Al), silver (Ag) or chromium (Cr).

In this embodiment, the reflective barrier 56 comprises a first polarizer 64, a switchable barrier panel 66 and a second polarizer 68. The switchable barrier panel 66 is disposed between the first polarizer 64 and the second polarizer 68.

The first polarizer 64 has a transmission axis 69 and an absorption axis 69′. The switchable barrier panel 66 comprises a first substrate 70, a twisted nematic (TN) liquid crystal layer 72 and a second substrate 74. The twisted nematic (TN) liquid crystal layer 72 is disposed between the first substrate 70 and the second substrate 74. There are driving electrode patterns (not shown) on the first substrate 70 and the second substrate 74. The liquid crystal layer 72 is between the driving electrode patterns of the first substrate 70 and the second substrate 74.

The first substrate 70 and the second substrate 74 may be glass or transparent plastic film. As the switchable barrier panel 66 turned on, the twisted nematic (TN) liquid crystal layer 72 is divided into an on-state area 76 and an off-state area 78 in an alternate arrangement. As shown in FIG. 2A, liquid crystals 80 are vertically arranged due to vertical electric field in the on-state area 76 and stay original arrangement in the off-state area 78. Through the first polarizer 64 and the second polarizer 68, the reflective barrier 56 becomes a barrier. At the time, the 3D display device 50 is able to display 3D images. By contrast, when the switchable barrier panel 66 is turned off (not shown), the 3D display device 50 is able to display 2D images.

In an embodiment, the second substrate 74 has a thickness less than a distance 82 between two the on-state areas (76, 76) or two off-state areas (78, 78).

In detail, the second polarizer 68 comprises a high-refractive-index polymer layer 84 and a low-refractive-index polymer layer 86 in an alternate arrangement, as shown in FIG. 2A. Some of the light will be reflected by the low-refractive-index polymer layer 86. The second polarizer 68 has both polarization function and reflection function. Additionally, the second polarizer 68 has a transmission axis 90 and a reflection axis 92.

Still referring to FIG. 2A, in this embodiment, specifically, the transmission axis 69 of the first polarizer 64 and the transmission axis 90 of the second polarizer 68 are substantially perpendicular to each other. The reflection axis 92 of the second polarizer 68 and the transmission axis 69 of the first polarizer 64 are substantially parallel to each other. The reflection axis 92 of the second polarizer 68 is perpendicular to the absorption axis 69′ of the first polarizer 64.

Referring to FIG. 2B, in this embodiment, when light 3 emitted from the backlight system 52 passes through the first polarizer 64, a first polarized light 4 with a polarization axis 4′ is formed (the polarization axis 4′ of the first polarized light 4 is parallel to the transmission axis 69 of the first polarizer 64). When the first polarized light 4 continuously passes through the off-state area 78 in the twisted nematic (TN) liquid crystal layer 72, the first polarized light 4 is rotated 90° by liquid crystals (LC) 80 to form a second polarized light 5 with a polarization axis 5′. The second polarizer 68 allows the second polarized light 5 to pass through due to the polarization axis 5′ of the second polarized light 5 being parallel to the transmission axis 90 of the second polarizer 68 such that the off-state area 78 in the twisted nematic (TN) liquid crystal layer 72 corresponds to a bright area (not shown) of the liquid crystal display (LCD) panel 58.

Further, referring to FIG. 2C, another light path is illustrated. When light 3 emitted from the backlight system 52 passes through the first polarizer 64, a polarized light 4 with a polarization axis 4′ is formed (the polarization axis 4′ of the polarized light 4 is parallel to the transmission axis 69 of the first polarizer 64). When the polarized light 4 continuously passes through the on-state area 76 in the twisted nematic (TN) liquid crystal layer 72, the polarized light 4 is not modulated (rotated) by liquid crystals (LC) 80 so that the direction of the polarization axis 4′ thereof is preserved (see polarized light 4-1). The polarized light 4-1 with the polarization axis 4′ is then reflected by the second polarizer 68 (see polarized light 4-2) due to the polarization axis 4′ of the polarized light 4-1 being parallel to the reflection axis 92 of the second polarizer 68. The reflected polarized light 4-2 then passes through the on-state area 76 in the twisted nematic (TN) liquid crystal layer 72 (the polarized light 4-2 is not modulated (rotated) by liquid crystals (LC) 80)(see polarized light 4-3), passes through the first polarizer 64 and reaches the reflector 54 of the backlight system 52. When the polarized light 4-3 is reflected by the reflector 54 again, an un-polarized light 3 is then formed and thus can be repeatedly used (improvement of brightness). Note that the on-state area 76 in the twisted nematic (TN) liquid crystal layer 72 corresponds to a dark area (not shown) of the liquid crystal display (LCD) panel 58.

In an embodiment, the brightness of the 3D display device 50 is improved from 27% (conventional switchable-barrier-type 3D display device) to about 35%.

In this embodiment, some structural features of the 3D display device 50 are: (1) the second polarizer 68 is a reflective polarizer rather than an absorption polarizer; (2) the second substrate 74 with a thin thickness is preferable, for example less than the distance 82 between the two on-state areas (76, 76) or two off-state areas (78, 78) due to alteration of light path; and (3) the 3D display device 50 is a switchable-barrier-type 3D display device.

Still referring to FIG. 2C, if the polarized light 4 passes through the on-state area 76 in the twisted nematic (TN) liquid crystal layer 72 but the reflected polarized light 4-2 passes through the off-state area 78 in the twisted nematic (TN) liquid crystal layer 72 (the polarized light 4-2 is rotated 90° by liquid crystals (LC) 80)(not shown), then the passed through polarized light will be absorbed by the first polarizer 64 due to the polarization axis of the passed through polarized light being parallel to the absorption axis 69′ of the first polarizer 64, resulting in an unwanted light path. However, in this embodiment, such an unwanted light path can be avoided by disposition of the thin second substrate 74, for example having a thickness less than the distance 82 between the two on-state areas (76, 76) or two off-state areas (78, 78) of the second substrate 74, to ensure that the polarized light 4 passes through the on-state area 76 in the twisted nematic (TN) liquid crystal layer 72 and the reflected polarized light 4-2 passes through the on-state area 76 in the twisted nematic (TN) liquid crystal layer 72.

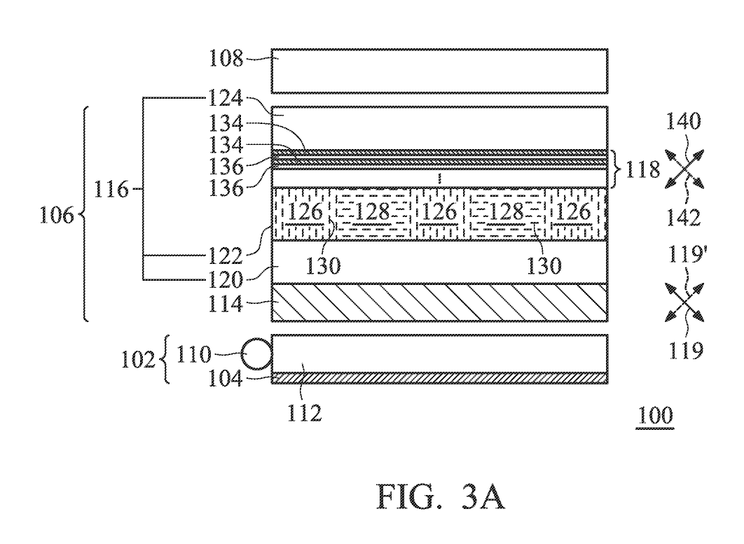

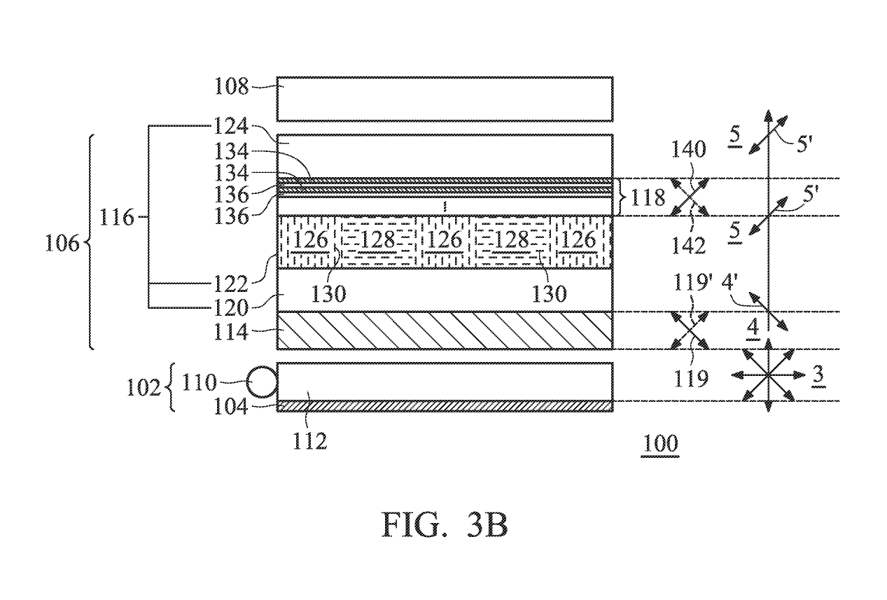

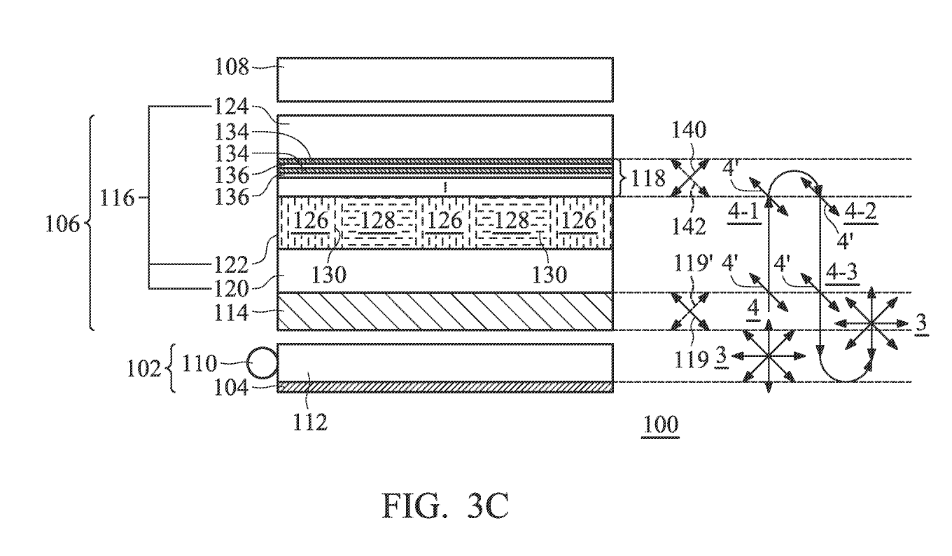

According to another embodiment of the invention, referring to FIG. 3A, a 3D display device with switchable barrier is illustrated. A 3D display device 100 comprises a backlight system 102, a reflective barrier 106 and a liquid crystal display (LCD) panel 108. The liquid crystal display (LCD) panel 108 is disposed above the reflective barrier 106. The liquid crystal display (LCD) panel 108 is a transmissive display panel for displaying images. The reflective barrier 106 is disposed between the liquid crystal display (LCD) panel 108 and the backlight system 102. In another embodiment, the liquid crystal display (LCD) panel 108 is disposed between the reflective barrier 106 and the backlight system to 102 (not shown).

In this embodiment, the backlight system 102 comprises at least one light source 110, one light guide plate 112, and one reflector 104. The reflector 104 is disposed under the light guide plate 112. Additionally, the reflector 104 may comprise metal such as aluminum (Al), silver (Ag) or chromium (Cr).

In this embodiment, the reflective barrier 106 comprises a first polarizer 114, a switchable barrier panel 116 and a second polarizer 118. The switchable barrier panel 116 is disposed on the first polarizer 114. Specifically, the second polarizer 118 is inserted into the switchable barrier panel 116.

The first polarizer 114 has a transmission axis 119 and an absorption axis 119′. The switchable barrier panel 116 comprises a first substrate 120, a twisted nematic (TN) liquid crystal layer 122 and a second substrate 124. The twisted nematic (TN) liquid crystal layer 122 is disposed on the first substrate 120. Specifically, the second polarizer 118 is disposed between the twisted nematic (TN) liquid crystal layer 122 and the second substrate 124. There are driving electrode patterns (not shown) on the first substrate 120 and the second substrate 124. The liquid crystal layer 122 is between the driving electrode patterns of the first substrate 120 and the second substrate 124.

The first substrate 120 and the second substrate 124 may be glass or transparent plastic film. Additionally, when the switchable barrier panel 116 is turned on, the twisted nematic (TN) liquid crystal layer 122 is divided into an on-state area 126 and an off-state area 128 in an alternate arrangement. In detail, in the on-state area 126, liquid crystals 130 are vertically arranged due to vertical electric field in the on-state area 126 and stay original arrangement in the off-state area 128. Through the first polarizer 114 and the second polarizer 118, the switchable barrier panel 116 becomes a barrier. At this time, the 3D display device 100 is able to display 3D images. By contrast, when the switchable barrier panel 116 is turned off (not shown), the 3D display device 100 is able to display 2D images.

In detail, the second polarizer 118 comprises a high-refractive-index polymer layer 134 and a low-refractive-index polymer layer 136 in an alternate arrangement, as shown in FIG. 3A. Some of the light will be reflected by the low-refractive-index polymer layer 136. The second polarizer 118 has both polarization function and reflection function. Additionally, the second polarizer 118 has a transmission axis 140 and a reflection axis 142.

Still referring to FIG. 3A, in this embodiment, specifically, the transmission axis 119 of the first polarizer 114 and the transmission axis 140 of the second polarizer 118 are substantially perpendicular to each other. However, the reflection axis 142 of the second polarizer 118 and the transmission axis 119 of the first polarizer 114 are substantially parallel to each other. The reflection axis 142 of the second polarizer 118 is perpendicular to the absorption axis 119′ of the first polarizer 114.

Referring to FIG. 3B, in this embodiment, when light 3 emitted from the backlight system 102 passes through the first polarizer 114, a first polarized light 4 with a polarization axis 4′ is formed (the polarization axis 4′ of the first polarized light 4 is parallel to the transmission axis 119 of the first polarizer 114). When the first polarized light 4 continuously passes through the off-state area 128 in the twisted nematic (TN) liquid crystal layer 122, the first polarized light 4 is rotated 90° by liquid crystals (LC) 130 to form a second polarized light 5 with a polarization axis 5′. The second polarizer 118 allows the second polarized light 5 to pass through due to the polarization axis 5′ of the second polarized light 5 being parallel to the transmission axis 140 of the second polarizer 118 such that the off-state area 128 in the twisted nematic (TN) liquid crystal layer 122 corresponds to a bright area (not shown) of the liquid crystal display (LCD) panel 108.

Further, referring to FIG. 3C, another light path is illustrated. When light 3 emitted from the backlight system 102 passes through the first polarizer 114, a polarized light 4 with a polarization axis 4′ is formed (the polarization axis 4′ of the polarized light 4 is parallel to the transmission axis 119 of the first polarizer 114). When the polarized light 4 continuously passes through the on-state area 126 in the twisted nematic (TN) liquid crystal layer 122, the polarized light 4 is not modulated (rotated) by liquid crystals (LC) 130 so that the direction of the polarization axis 4′ thereof is preserved (see polarized light 4-1). The polarized light 4-1 with the polarization axis 4′ is then reflected by the second polarizer 118 (see polarized light 4-2) due to the polarization axis 4′ of the polarized light 4-1 being parallel to the reflection axis 142 of the second polarizer 118. The reflected polarized light 4-2 then passes through the on-state area 126 in the twisted nematic (TN) liquid crystal layer 122 (the polarized light 4-2 is not modulated (rotated) by liquid crystals (LC) 130)(see polarized light 4-3), passes through the first polarizer 114 and reaches the reflector 104 of the backlight system 102. When the polarized light 4-3 is reflected by the reflector 104 again, an un-polarized light 3 is then formed and thus can be repeatedly used (improvement of brightness). Additionally, the on-state area 126 in the twisted nematic (TN) liquid crystal layer 122 corresponds to a dark area (not shown) of the liquid crystal display (LCD) panel 108.

In an embodiment, the brightness of the 3D display device 100 is improved from 27% (conventional switchable-barrier-type 3D display device) to about 35%.

In this embodiment, some structural features of the 3D display device 100 are: (1) the second polarizer 118 is inserted into the switchable barrier panel 116, for example, inserted between the twisted nematic (TN) liquid crystal layer 122 and the second substrate 124; and (2) the 3D display device 100 is a switchable-barrier-type 3D display device.

Still referring to FIG. 3C, if the polarized light 4 passes through the on-state area 126 in the twisted nematic (TN) liquid crystal layer 122 but the reflected polarized light 4-2 passes through the off-state area 128 in the twisted nematic (TN) liquid crystal layer 122 (the polarized light 4-2 is rotated 90° by liquid crystals (LC) 130)(not shown), then the passed through polarized light will be absorbed by the first polarizer 114 due to the polarization axis of the passed through polarized light being parallel to the absorption axis 119′ of the first polarizer 114, resulting in an unwanted light path. However, in this embodiment, such an unwanted light path can be avoided by inserting the second polarizer 118 into the switchable barrier panel 116, to ensure that the polarized light 4 passes through the on-state area 126 in the twisted nematic (TN) liquid crystal layer 122 and the reflected polarized light 4-2 passes through the on-state area 126 in the twisted nematic (TN) liquid crystal layer 122.

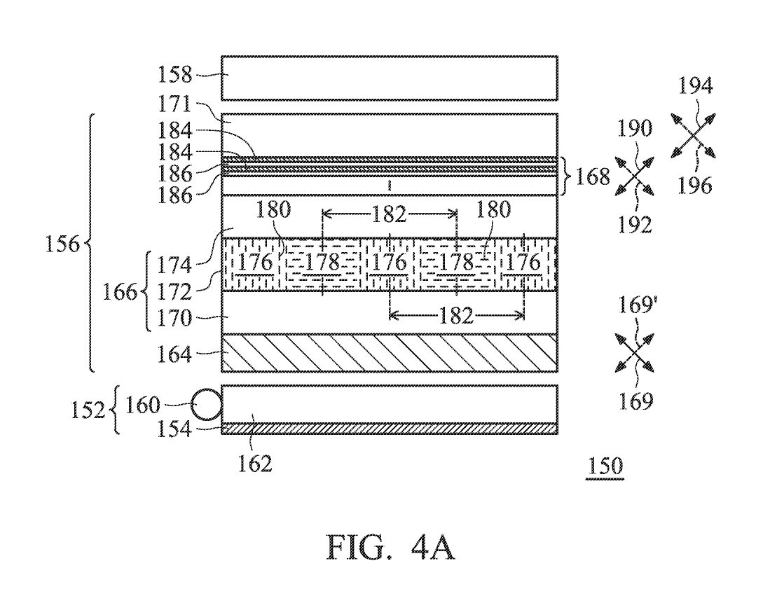

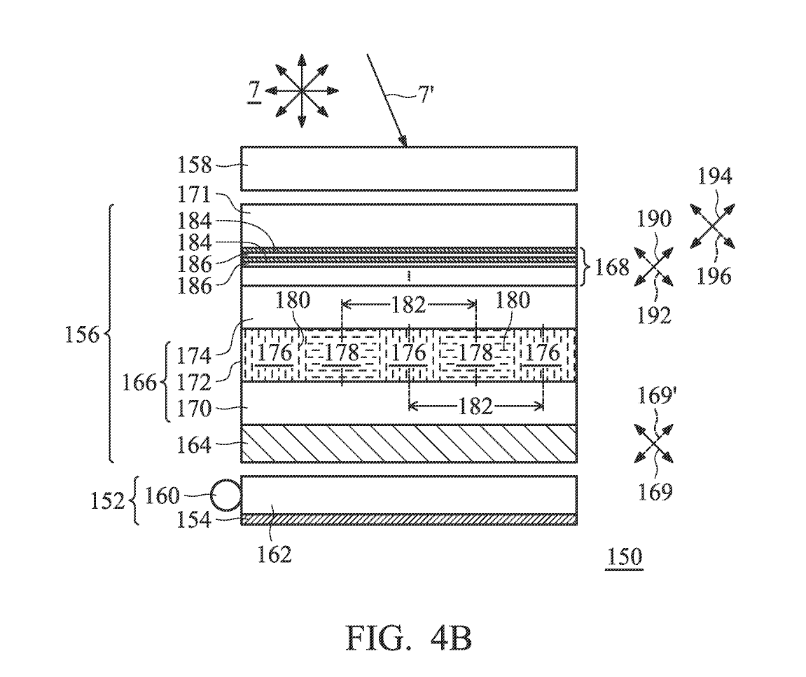

According to another embodiment of the invention, referring to FIG. 4A, a 3D display device with switchable barrier is illustrated. A 3D display device 150 comprises a backlight system 152 a reflective barrier 156 and a liquid crystal display (LCD) panel 158. The liquid crystal display (LCD) panel 158 is disposed above the reflective barrier 156. The liquid crystal display (LCD) panel 158 is a transmissive display panel for displaying images. The reflector 154 is disposed under the backlight system 152. The reflective barrier 156 is disposed between the liquid crystal display (LCD) panel 158 and the backlight system 152. In another embodiment, the liquid crystal display (LCD) panel 158 is disposed between the reflective barrier 156 and the backlight system 152 (not shown).

In this embodiment, the backlight system 152 comprises at least one light source 160, one light guide plate 162 and one reflector 154, such that the reflector 154 is disposed under the light guide plate 162. Additionally, the reflector 154 may comprise metal such as aluminum (Al), silver (Ag) or chromium (Cr).

In this embodiment, the reflective barrier 156 comprises a first polarizer 164, a switchable barrier panel 166, a second polarizer 168 and a third polarizer 171. The switchable barrier panel 166 is disposed between the first polarizer 164 and the second polarizer 168. The third polarizer 171 is disposed on the second polarizer 168.

The first polarizer 164 has a transmission axis 169 and an absorption axis 169′. The switchable barrier panel 166 comprises a first substrate 170, a twisted nematic (TN) liquid crystal layer 172 and a second substrate 174. The twisted nematic (TN) liquid crystal layer 172 is disposed on the first substrate 170 and the second substrate 174. There are driving electrode patterns (not shown) on the first substrate 170 and the second substrate 174. The liquid crystal layer 172 is between the driving electrode patterns of the first substrate 170 and the second substrate 174.

The first substrate 170 and the second substrate 174 may be glass or transparent plastic film. Additionally, when the switchable barrier panel 166 is turned on, the twisted nematic (TN) liquid crystal layer 172 is divided into an on-state area 176 and an off-state area 178 in an alternate arrangement. In detail, in the on-state area 176, liquid crystals 180 are vertically arranged due to vertical electric field in the on-state area 176 and stay original arrangement in the off-state area 178. Through the first polarizer 164 and the second polarizer 168 and the third polarizer 171, the reflective barrier 156 becomes a barrier. At this time, the 3D display device 150 is able to display 3D images. By contrast, when the switchable barrier panel 166 is turned off (not shown), the 3D display device 150 is able to display 2D images.

In an embodiment, the second substrate 174 has a thickness less than a distance 182 between the two on-state areas (176, 176) or two off-state areas (178, 178).

In detail, the second polarizer 168 comprises a high-refractive-index polymer layer 184 and a low-refractive-index polymer layer 186 in an alternate arrangement, as shown in FIG. 4A. The second polarizer 168 has a transmission axis 190 and a reflection axis 192. Additionally, the third polarizer 171 comprises a first base film, a polarized film and a second base film (not shown). The third polarizer 171 has a transmission axis 194 and an absorption axis 196.

Still referring to FIG. 4A, in this embodiment, the transmission axis 169 of the first polarizer 164 and the transmission axis 190 of the second polarizer 168 are substantially perpendicular to each other. The reflection axis 192 of the second polarizer 168 and the transmission axis 169 of the first polarizer 164 are substantially parallel to each other. Specifically, with regard to the second polarizer 168 and the third polarizer 171, the transmission axis 190 of the second polarizer 168 and the transmission axis 194 of the third polarizer 171 are substantially parallel to each other. The absorption axis 196 of the third polarizer 171 and the reflection axis 192 of the second polarizer 168 are substantially parallel to each other.

In this embodiment, the light paths within the 3D display device 150 are similar to FIGS. 2B and 2C and the brightness of the 3D display device 150 is also improved.

In an embodiment, the brightness of the 3D display device 150 is improved from 27% (conventional switchable-barrier-type 3D display device) to about 35%.

In this embodiment, some structural features of the 3D display device 150 are: (1) a composite polarizer including the second polarizer 168 (reflective polarizer) and the third polarizer 171 (absorption polarizer) disposed thereon having transmission axes (190, 194) and being parallel to each other, is disposed on the switchable barrier panel 166; (2) the absorption axis 196 of the third polarizer 171 and the reflection axis 192 of the second polarizer 168 are parallel to each other; and (3) the 3D display device 150 is a switchable-barrier-type 3D display device.

Referring to FIG. 4B, under sunlight 7, a polarized light with a polarization axis 7′ parallel to the reflection axis 192 of the second polarizer 168 is absorbed by the third polarizer 171 due to the absorption axis 196 of the third polarizer 171 being parallel to the reflection axis 192 of the second polarizer 168, improving sunlight readability (low surface reflection).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A 3D display device, comprising:
a backlight system with a reflector disposed thereunder;
a reflective barrier disposed above the backlight system; and
a liquid crystal display (LCD) panel disposed above the backlight system.

2. The 3D display device as claimed in claim 1, wherein the reflective barrier is disposed between the liquid crystal display panel and the backlight system.

3. The 3D display device as claimed in claim 1, wherein the liquid crystal display panel is disposed between the reflective barrier and the backlight system.

4. The 3D display device as claimed in claim 1, wherein the reflective barrier comprises a plurality of protrusions.

5. The 3D display device as claimed in claim 4, wherein the protrusion comprises an anti-reflective layer and a reflective layer disposed thereon.

6. The 3D display device as claimed in claim 1, wherein the reflective barrier comprises a first polarizer, a switchable barrier panel and a second polarizer.

7. The 3D display device as claimed in claim 6, wherein the switchable barrier panel comprises a first substrate, a liquid crystal layer and a second substrate.

8. The 3D display device as claimed in claim 7, wherein the liquid crystal layer is divided into an on-state area and an off-state area in an alternate arrangement.

9. The 3D display device as claimed in claim 8, wherein liquid crystals are vertically arranged in the on-state area.

10. The 3D display device as claimed in claim 7, wherein the first substrate is disposed between the first polarizer and the liquid crystal layer, and the second

11. The 3D display device as claimed in claim 9, wherein the second substrate has a thickness less than a distance between the two on-state areas or two off-state areas.

12. The 3D display device as claimed in claim 6, wherein the second polarizer comprises a high-refractive-index polymer layer and a low-refractive-index polymer layer in an alternate arrangement.

13. The 3D display device as claimed in claim 6, wherein the first polarizer has a transmission axis substantially perpendicular to a transmission axis of the second polarizer.

14. The 3D display device as claimed in claim 13, wherein the second polarizer has a reflection axis substantially parallel to the transmission axis of the first polarizer.

15. The 3D display device as claimed in claim 10, further comprising a third polarizer disposed on the second polarizer.

16. The 3D display device as claimed in claim 15, wherein the second polarizer has a transmission axis substantially parallel to a transmission axis of the third polarizer.

17. The 3D display device as claimed in claim 15, wherein the third polarizer has an absorption axis substantially parallel to a reflection axis of the second polarizer.
